(19) United States
(12) Patent Application Publication
(10) Pub. No.: US 2026/0227192 A1
(43) Pub. Date: Aug. 6, 2026

(54) Computer-Implemented System and Method for Generating Map Data With Energy Consumption Forecast Values

(71) Applicant: Bayerische Motoren Werke Aktiengesellschaft, Muenchen (DE)

(72) Inventor: Caglayan Erdem, Augsburg (DE)

(21) Appl. No.: 19/153,311

(22) PCT Filed: Dec. 5, 2023
(86) PCT No.: PCT/EP2023/084321

§ 371 Date: Aug. 1, 2025

(30) Foreign Application Priority Data
Feb. 14, 2023 (DE) 10 2023 103 530.4

(51) Int. Cl. G01C 21/34; B60L 58/24; G06N 20/20

(52) U.S. Cl. CPC G01C 21/3469; B60L 58/24; G01C 21/3446; G06N 20/20; B60L 2240/622; B60L 2260/54

(57) ABSTRACT

A computer-implemented method for generating map data with energy consumption forecast values for use in energy management of an electric vehicle is disclosed herein. The method includes loading base map data which comprises a network of road sections. The method further includes carrying out the following actions for each road section: determining a set of neighboring road sections using the base map data, calculating transition vectors for each combination of the road section and a neighboring road section using the base map data, calculating an energy consumption value for each transition vector using an energy consumption forecast model, and calculating an energy consumption forecast value of the road section using the calculated energy consumption value for each transition vector. Additionally, the method includes providing map data comprising the network of road sections and the calculated energy consumption forecast values.

### CROSS-REFERENCE TO RELATED APPLICATIONS

The present application is the U.S. national phase of PCT Application PCT/EP2023/084321 filed on Dec. 12, 2023, which claims priority of German patent application No. 10 2023 103 530.4 filed on Feb. 14, 2023, the entire contents of which are incorporated herein by reference.

### FIELD

The disclosure herein relates to a computer-implemented method for generating map data with energy consumption forecast values, in particular for use in the energy management of an electric vehicle.

### BACKGROUND

Electric vehicles, in particular battery-powered electric vehicles, are seen as an important contribution to the transport transition and are already indispensable to modern mobility. In contrast to vehicles with conventional combustion engines, battery-powered electric vehicles are powered by an electric motor, which is supplied with energy by a battery. The battery must therefore be charged regularly. Typically, however, the motion energy of the vehicle is also used to restore energy to the battery when driving downhill or during braking.

Various factors influence the performance of the batteries installed in electric vehicles. A crucial factor is the temperature at which the battery is operated: typically, the batteries have a temperature range in which the performance is maximum, because this is where the electrochemical processes work optimally. For example, this temperature range can be between 20 and 40 degrees Celsius. Operating the battery outside the preferred temperature range may shorten the range of the electric vehicle because the battery does not perform at full capacity. In addition, signs of battery wear can occur, which results in a gradual reduction in battery capacity (degradation).

To counteract the above-mentioned problems (degradation, range reduction), solutions are known, for example, which heat up the battery before the vehicle is driven, so that the battery reaches its preferred temperature range at the start of the journey.

In view of the foregoing, it would be advantageous to reduce the degradation of the battery of an electric vehicle.

### SUMMARY

Advantageous embodiments of the disclosure herein include a computer-implemented method for generating map data with energy consumption forecast values. The method or the generated map data can be used in particular in the energy management of an electric vehicle. The method comprises the following steps:
a) loading base map data, which comprises a network of road sections;
b) carrying out the following steps for each road section:
   b1) determining a set of neighboring road sections using the base map data;
   b2) calculating transition vectors for each combination of the road section and a neighboring road section using the base map data;
   b3) calculating an energy consumption value for each transition vector using an energy consumption forecast model;
   b4) calculating an energy consumption forecast value of the road section using the calculated energy consumption values;
c) providing map data comprising the network of road sections and the associated energy consumption forecast values.

A network of road sections can be understood within the context of this disclosure to mean a data structure that describes a set of interconnected road sections. Such a data structure can be, for example, a directed graph. The base map data can thus be in particular digital map data, as usually used for vehicle navigation. In addition to the network of road sections, such map data typically includes additional information for each road section, such as length, maximum permitted speed, road type, and so on.

One idea of the present disclosure is to predict the energy demand of the electric vehicle on respective road sections. With regard to degradation, particularly high power demands should be treated as critical if the battery is outside the preferred temperature range, for example when starting the vehicle in winter. Such high power demands can be caused, for example, by sharp accelerations, high speeds or uphill driving.

According to the described method, each road section is evaluated in the context of its surrounding road sections and an energy consumption forecast value for the road section is derived from this overall analysis. This is based on the idea that the power demand of an electric vehicle on a current road section can be influenced by a subsequent road section. For example, on a freeway entrance road (current road section) a high power demand is to be expected, as the driver accelerates the vehicle up to a higher speed that is appropriate or approved for the freeway (subsequent road section). Conversely, for example, on freeway exit roads, a low power demand or even energy recovery is to be expected, since the vehicle is braked from a high speed and may possibly recover energy by recuperation.

Generally, the described approach is reproduced in the method according to the disclosure herein by the steps b1) to b4) of the method, which are carried out separately for each individual road section.

For this purpose, according to step b1), the set of neighboring road sections for the road section under consideration is determined using the base map data. Neighboring road sections are road sections from the base map data that are located in an environment of the road section under consideration (e.g. immediate predecessors/successors of the road section under consideration).

In step b2), a transition vector is then calculated for each combination of the road section under consideration and one of its neighboring road sections. The transition vector can describe changes in relevant parameters (such as maximum speed or gradient) that occur on a transition between the road section under consideration and the neighboring road section. The parameter values of the individual road sections are included in the base map data. The result is a set of transition vectors that describe parameter changes for each possible transition from the road section to one of its neighboring road sections (or vice versa).

In step b3), an energy consumption value is determined for each of the calculated transition vectors using an energy consumption forecast model. The calculated energy consumption value describes the expected energy consumption of the vehicle, assuming that the vehicle drives from the selected road section to the neighboring road section, or arrives at the selected road section from the neighboring road section.

In step b4), an energy consumption forecast value for the selected road section is calculated using the calculated energy consumption values. For example, one of the energy consumption values calculated in step b3) can be selected, for example the highest (for a worst-case estimate).

Finally, according to the described method, map data is provided which contains the calculated energy consumption forecast value for each road section. In particular, the map data can be created on the basis of the base map data, the calculated energy consumption forecast values being included as additional attributes of the road sections. In this case, the map data provided can be interpreted as a marked (labeled) version of the base maps.

Thus, the method is able to generate map data containing accurate information about the power demands to be expected on individual road sections. This information can be used in the energy management of an electric vehicle to select a suitable and efficient operating strategy for the electric vehicle. For example, preheating of the battery can be carried out (only) when a high power demand is to be expected on a road section, which the electric vehicle will reach (quickly) after the vehicle starts. This improves the energy efficiency of the electric vehicle.

In one embodiment, the set of neighboring road sections can contain all road sections that are directly connected to the road section. In this case, in the network of road sections, the neighboring road sections of the road section under consideration can be regarded as its direct predecessors or successors.

The definition of the neighboring road sections as immediate predecessors/successors, on which this embodiment is based, has proven in practical experiments to be particularly suitable for producing accurate energy consumption forecast values.

Alternatively, the set of neighboring road sections can also contain all road sections that are connected to the road section by at least one further road section. In this embodiment, the neighbor relation is thus extended to indirectly connected road sections.

In a further embodiment, the base maps for at least some of the road sections may have one or more of the following values: speed limit, road type, gradient, length. Preferably, the base map data contains all the parameters mentioned for all road sections. Thus, the parameters that are particularly relevant to the energy consumption of the electric vehicle can be represented in the transition vectors as comprehensively as possible.

In a further embodiment, the transition vectors may have one or more of the following values: difference in speed limit, change of road type, gradient difference.

As already explained in connection with the above comments, the comprehensive modeling of different parameters or their changes at the transition between road sections enhances the quality of the generated energy consumption forecast values.

In one embodiment, the energy consumption forecast model may comprise at least one regression model. The regression model contains a mapping rule from transition vectors to energy consumption values.

In a simple implementation, the regression model can be provided by a function that weights the components of the input transition vector and determines the energy consumption value from the weighted sum. In particular, the regression model may be a trained model, for example a trained neural network. Training data can be provided by data sets that indicate the actual energy requirements of the electric vehicle on a particular road section.

In one embodiment, the regression model may contain at least one decision tree, preferably a random forest of decision trees.

The method, or energy consumption forecast model, can perform a regression according to a random forest method, in which the regression is performed on the basis of multiple uncorrelated decision trees that have grown in a randomized manner during the training process.

The use of a random forest approach has proven to be effective in the present disclosure and offers the advantage that even with a small set of training data, a high quality regression is carried out.

In a further embodiment, in step b4), the energy consumption forecast value of the road section corresponds to the largest of the energy consumption values calculated in step b3). This means that the energy consumption forecast value of a road section is set to the highest energy consumption value that is obtained when all possible combinations of the road section with one of its neighboring road sections are considered.

The described embodiment results in a worst-case estimate in which each road section is assigned the highest possible energy consumption resulting from the transition from/to a single neighboring road section-regardless of how likely this transition is. Such a worst-case estimate can be useful, for example, in selecting an operating strategy for the electric vehicle, in which a degradation of the battery is to be prevented.

In an alternative embodiment, the energy consumption forecast value determined in step b4) corresponds to a weighted mean of the energy consumption values calculated in step b3). For example, the weights can reflect the (statistical) probability that the electric vehicle will drive across the corresponding transition of the road sections.

This alternative embodiment may allow a more precise estimation of the expected energy consumption.

According to a further embodiment, the method can also comprise the following steps:
d) determining a GPS location of an electric vehicle;
e) determining a, in particular maximum, reference energy consumption forecast value in the environment of the electric vehicle according to the GPS location using the map data.

According to this embodiment, the generated map data is used to determine a reference value for the energy consumption of the electric vehicle, which is expected in the (current) environment of the electric vehicle. The reference value may in particular be the maximum energy consumption forecast value of all road sections in the environment, for a worst-case estimate. This embodiment is based in particular on the idea that maximum power demands shortly after the electric vehicle starts up at low temperature can exacerbate the degradation of the battery.

To determine the environment, a GPS location of the electric vehicle is first determined, for example via a GPS sensor integrated in the vehicle.

The environment of the vehicle can be understood as the set of road sections that can be expected to be reached in a short time and/or a short distance, based on the current GPS location of the vehicle.

For example, the environment can be understood as a set of road sections located within a predefined radius starting from the GPS location of the electric vehicle. For example, the predefined radius can be 5 km. Alternatively, the environment may include all road sections that can be reached within a predefined time (e.g. 10 minutes) after the electric vehicle starts up. In addition, the environment can be defined depending on a specified navigation target.

In a further embodiment, the method can also comprise the following step:
f) adjusting an energy management configuration of the electric vehicle, in particular for preheating a battery of the electric vehicle, based on a reference energy consumption forecast value.

The energy management configuration of the electric vehicle can control, for example, whether a preheating process of the electric vehicle battery is carried out before the start of the journey, optionally depending on the outside temperature.

Depending on the reference energy consumption forecast value, the preheating process can be initiated, for example, if the reference energy consumption forecast value exceeds a threshold value. In addition, other parameters can be taken into account, such as the current state of charge of the battery, the outside temperature, the age of the battery, and similar parameters.

In this embodiment, it is thus possible, in particular in combination with the previously described embodiment, to use the generated energy consumption forecast values in the energy management of the electric vehicle in order to adapt its operating strategy accordingly. This improves the energy efficiency of the electric vehicle and can prevent the problems described in the introduction, such as degradation and shortening of range.

The above-described advantages may also be achieved by a computer-readable storage medium. The computer-readable storage medium contains instructions which cause at least one processor to implement a method as described above when the instructions are executed by the at least one processor.

With regard to the computer-readable storage medium, similar advantages and technical effects arise as have been described in connection with the method according to the disclosure herein.

The above-described advantages may also be achieved by a system for generating map data with energy consumption forecast values, in particular for use in the energy management of an electric vehicle. The system comprises the following:
at least one memory, containing an energy consumption forecast model and/or base map data, which comprises a network of road sections;
a backend computing device which is designed to carry out the following steps:
a) loading the base map data;
b) carrying out the following steps for each road section:
   b1) determining a set of neighboring road sections using the base map data;
   b2) calculating transition vectors for each combination of the road section and a neighboring road section using the base map data;
   b3) calculating an energy consumption value for each transition vector using the energy consumption forecast model;
   b4) calculating an energy consumption forecast value of the road section using the calculated energy consumption values;
c) providing map data comprising the network of road sections and the associated energy consumption forecast values.

With regard to the system, similar advantages and technical effects arise as have been described in connection with the method according to the disclosure herein.

In one embodiment the system can further comprise an electric vehicle, which comprises the following:
a GPS sensor;
a communication device; and
a vehicle computing device.

The vehicle computing device is configured
to determine a position of the electric vehicle using the GPS sensor;
to transmit the position to the backend computing device by means of the communication device;
to receive a reference energy consumption forecast value from the backend computing device by means of the communication device.

The backend computing device is additionally designed to determine the reference energy consumption forecast value based on the position and the map data and to transmit said value to the communication device.

In particular, the reference energy consumption forecast value can be the maximum energy consumption forecast value of a road section which is located in the environment of the vehicle location.

In one embodiment, the electric vehicle may further comprise the following:
an energy management device; and
a heater for heating battery of the electric vehicle.

The energy management device is designed to control the heater depending on the reference energy consumption forecast value. Alternatively or additionally, a cooling device, e.g. a fan or an air-conditioning unit, can be controlled, for example activated, as a function of the reference energy consumption forecast value.

For this embodiment of the system, similar advantages and technical effects arise as have already been described in connection with the corresponding embodiments of the method.

It goes without saying that the features and the respective benefits that can be thereby achieved, which have been described in relation to the method according to the disclosure herein, are applicable or transferable to the devices according to the disclosure and vice versa. Specifically, the components of the devices in the context of the present disclosure are designed to carry out the method steps according to the disclosure. Likewise, the functions of the components of the devices according to the disclosure herein are applicable as method steps of the method according to the disclosure.

### BRIEF DESCRIPTION OF THE DRAWINGS

The disclosure herein is made on the basis of exemplary embodiments, which are explained in more detail using illustrations. In the drawings:

FIG. 1a: shows base map data according to an exemplary embodiment;

FIG. 1b: shows a set of neighboring road sections in the exemplary embodiment of FIG. 1a;

FIG. 2: shows a flow diagram of a method in accordance with an exemplary embodiment;

FIG. 3: shows a system in accordance with an exemplary embodiment.

In the description that follows, the same reference signs are used for the identical and identically acting parts.

### DESCRIPTION

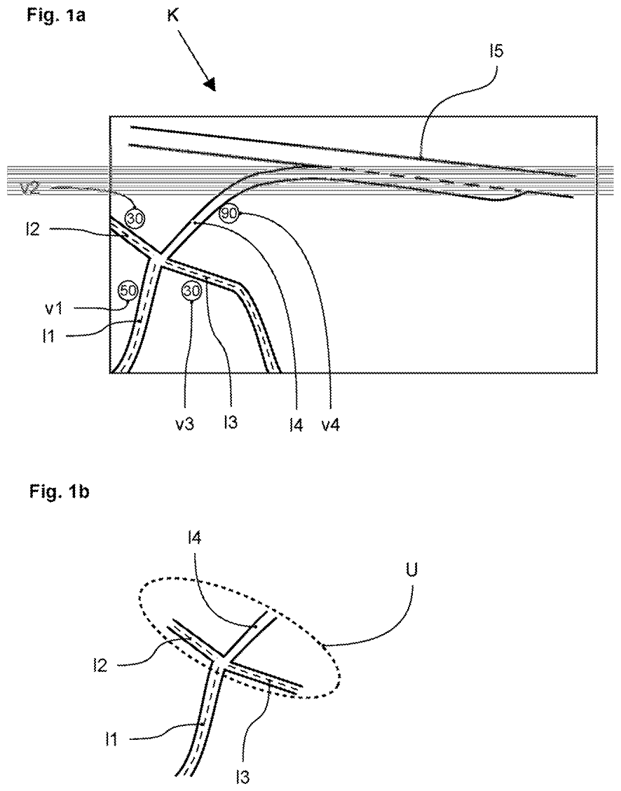

FIG. 1a shows a graphical representation of base map data K according to an exemplary embodiment.

The base map data K contains five road sections I1, I2, I3, I4 and I5. The road sections I1, I2, I3 and I4 each run in different directions and form a common intersection. Road section I4 is an entrance to the freeway, which corresponds to road section I5.

In addition, the base map data includes speed limits v1, v2, v3, v4 for each of the road sections I1, I2, I3, and I4:
On road section I1, the speed limit v1 (=50 km/h) applies.
On road section I2, the speed limit v2 (=30 km/h) applies.
On road section I3, the speed limit v3 (=40 km/h) applies.
On road section I4, the speed limit v4 (=90 km/h) applies.

FIG. 1b shows an enlarged section of FIG. 1a for illustrating the neighboring road sections of the road section I1.

Road section I1 is connected to the road sections I2, I3 and I4. A vehicle approaching the common intersection of road sections I1, I2, I3 and I4 on road section I1 can therefore drive onto road section I2 by turning left, onto road section I4 by driving straight ahead and thus in the direction of the freeway I5, or onto road section I3 by turning right.

Thus, each of the road sections I2, I3, I4 are connected as immediate successor road sections of road section I1. For road section I1, the set U of the neighboring road sections is therefore

$$U = \{ I 2 , I 3 , I 4 \} .$$

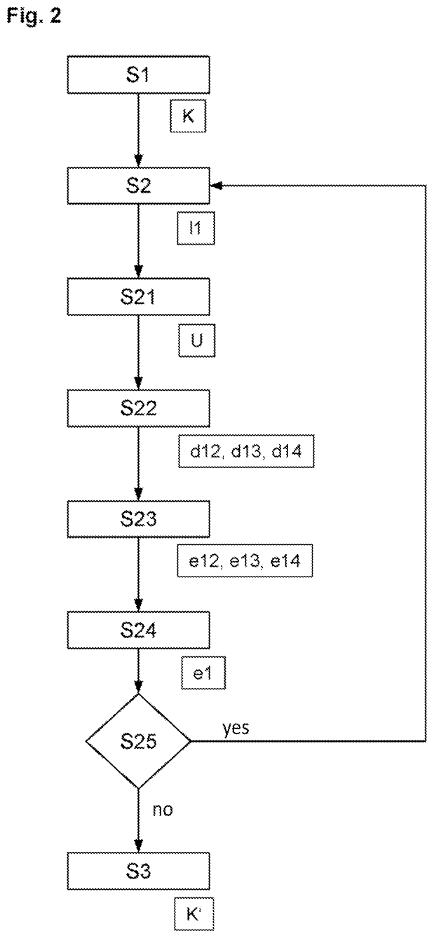

FIG. 2 shows a sequence of the method according to an exemplary embodiment. With regard to the base map data, reference is made to the exemplary embodiment of FIGS. 1a and 1b.

In step S1, the base map data K is loaded, which contains the network of road sections I1 to I5 and corresponding speed limits v1 to v4 as additional information (cf. FIG. 1a).

In step S2, any one of the road sections I1 to I5 is selected for which an energy consumption forecast value has not yet been calculated. For this purpose, the road sections still to be processed can be managed in a suitable data structure, for example in a stack. According to this exemplary embodiment, it is assumed that the road section I1 is chosen. The following steps S21, S22, S23, S24 refer to the road section I1 selected in step S2.

In step S21, the set U of the neighboring road sections is determined for road section I1. As shown in FIG. 1b, the set U in this exemplary embodiment contains just the road sections 12, 13, 14.

In step S22, transition vectors d12, d13, d14 are calculated for each combination of the selected road section I1 and one of its neighboring road sections I2, I3 and I4, i.e. for the combinations {I1, I2}, {I1, I3} and {I1, I4}. Each component of a transition vector d12, d13, d14 contains a difference in the speed limits of the respective road sections.

For example, the transition vector d14 (for the combination of road sections {I1, I4}) thus contains the following speed limit difference:

$$v 4 - v 1 = 90 km / h - 50 km / h = 40 km / h .$$

Thus the corresponding transition vector is given by d14=(40 km/h).

The other transition vectors d12 (combination {I1, I2}) and d13 (transition {I1, I3}) are given by:

$$d 12 = ( v 2 - v 1 ) = ( 30 km / h - 50 km / h ) = ( - 20 km / h ) ;$$

$$and$$

$$d 13 = ( v 3 - v 1 ) = ( 50 km / h - 50 km / h ) = ( 0 km / h ) .$$

In step S23, using the energy consumption forecast model, an energy consumption forecast value e12, e13, e14 is determined for each of the previously calculated transition vectors d12, d13, d14, for example in the unit Joule per meter (J/m). For this embodiment, the following values are assumed:

$$e 12 = 50 J / m ;$$

$$e 13 = 1000 J / m ; and$$

$$e 14 = 3000 J / m .$$

These values correspond to the expected energy consumption values, assuming in each case that the vehicle is traveling from road section I1 to the respective subsequent road section. The lowest energy consumption value is obtained for the transition I1-I2, since when changing from the section road with a permissible maximum speed of 50 km/h to a road section with a permissible maximum speed of 30 km/h the vehicle is likely to brake, or at least not to accelerate. On the other hand, the highest energy consumption value is obtained for the transition I1-I4, as here the vehicle is likely to accelerate to reach the higher permissible maximum speed (90 km/h instead of 50 km/h).

In step S24, the energy consumption forecast value e1 for road section I1 is calculated or selected. In this exemplary embodiment, the largest of the previously calculated energy consumption values is selected. The energy consumption forecast value e1 for the road section I1 thus corresponds to:

$$e 1 = max \{ e 12 , e 13 , e 14 \} = e 14 = 3000 J / m .$$

This corresponds to the assumption of the highest possible expected energy consumption, i.e. the assumption that the vehicle changes from road section I1 to road section I4.

This completes the calculation of the energy consumption forecast value e1 for the road section I1 selected in step S2.

In step S25 it is checked whether there are any road sections left for which no energy consumption forecast value has been calculated. In this case, the method is continued in step S2, otherwise in step S3.

In step S3, the base map data is extended to include the calculated energy consumption forecast values, in particular the energy consumption value e1=3000 J/m for the road section I1. The extended base map data is provided as map data K′.

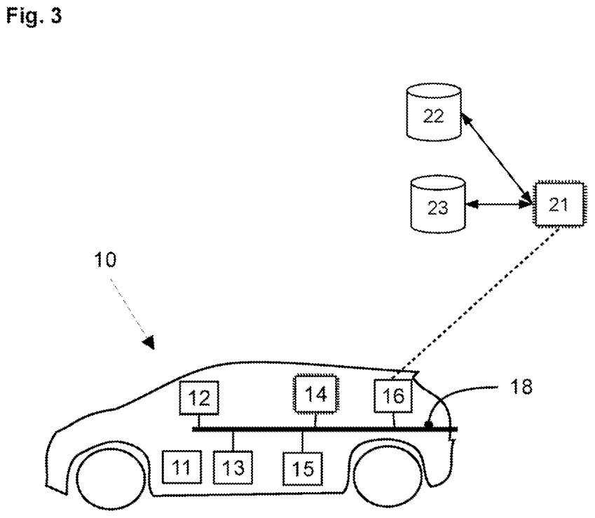

FIG. 3 shows an exemplary embodiment of the system according to the disclosure.

The system comprises the electric vehicle 10, which has the following components:
the battery 11 for powering the electric vehicle 10;
the heater 13 for preheating the battery 11;
the energy management device 12;
the on-board computer 14;
the GPS sensor 15; and
the mobile communication device 16.

In this exemplary embodiment, it is assumed that the components 12 to 16 of the vehicle 10 can communicate via a common bus 18.

The energy management device 12 is designed to perform a preheating process of the battery 11 by means of the heater 13.

The system further comprises a backend computing device 21, which is communicatively connected to the two databases 22 and 23. The database 22 contains a trained energy consumption forecast model. The database 23 contains base map data and/or map data with energy consumption forecast values, which have been generated by means of the backend computing device, as has been described in connection with the exemplary embodiment of FIG. 2.

The system shown is designed to implement the described method. In particular, in the system described, it is possible to operate a predictive energy management for the electric vehicle 10 by using the calculated energy consumption forecast values. In particular, the on-board computer 16 is designed to detect a GPS location of the electric vehicle 10 by means of the GPS sensor 15 and to transmit the location to the backend computing device 21 by means of the mobile communication device 16. The backend computing device 21 can determine a reference energy consumption forecast value using the map data on the basis of the received GPS position and send the value back to the vehicle. For example, as described in connection with the method, this could be the maximum energy consumption forecast value that exists within a radius of 5 km around the GPS location. The on-board computer 14 is designed to provide the received reference energy consumption value of the energy management device 12. The energy management device 12 is designed to perform a preheating process of the battery 11 by means of the heater 13, provided that the received reference energy consumption forecast value exceeds a defined threshold value.

The preceding exemplary embodiments are presented in a partially simplified manner and can only be understood as examples. It goes without saying that various deviations and modifications are conceivable without departing from the essence of the present disclosure.

For example, in FIG. 1, only the directly connected road sections I2, I3 and I4 are considered as neighboring road sections of the road section I1. In a modified definition, however, the road section I5 could also be considered as a neighboring road section of the road section I1, since both are connected to each other by the road section I4.

In the exemplary embodiment of FIG. 2, the attributes of the road sections and the change vectors are limited to speed values for the sake of simplicity. For a complete energy consumption forecast, it is of course advantageous to consider other attributes (such as gradient, road type, etc.). In such cases, the change vectors have correspondingly more components, for which a different type of regression or classification by the forecast model should be provided.

In FIG. 3, the components of the vehicle are connected to a common vehicle bus, purely to simplify the explanation. It goes without saying that the aforementioned components can also communicate via different bus systems or in other ways, as long as the vehicle computing device can retrieve the corresponding data. The databases 22, 23 can also be combined in a database or memory.

At this point, it should be pointed out that all the above-described parts, both individually- and without any additional features described in the respective context, even if these have not been explicitly identified as optional features in the respective context, e.g. by using: in particular, preferably, for example, e.g., optionally, round brackets, etc.—and in combination or any subcombination, are each to be regarded as independent embodiments or refinements of the disclosure, as defined in particular in the introduction to the description and the claims. Deviations from this are possible. Specifically, it should be pointed out that the phrase ‘in particular’, or round brackets, do not identify any mandatory features in the context in question.

### LIST OF REFERENCE SIGNS

10 electric vehicle
11 battery
12 energy management device
13 heater
14 on-board computer
15 GPS sensor
16 mobile communication device
18 bus
21 backend computing device
22, 23 database
K base map data
K′map data
d12, d13, d14 transition vectors
e12, e13, e14 energy consumption values
e1 energy consumption value (for road section I1)
I1, I2, I3, I4, I5 road section
v1, v2, v3, v4 speed limit
U set of neighboring road sections
S1 loading the base map data
S2 selecting a road section
S21 identifying the neighboring road sections
S22 calculating the transition vectors
S23 calculating the energy consumption values
S24 calculating the energy consumption forecast value
S25 checking for unprocessed road sections
S3: providing the map data

1.-14. (canceled)

15. A computer-implemented method for generating map data with energy consumption forecast values for use in energy management of an electric vehicle, the method comprising:
a) loading base map data which comprises a network of road sections;
b) carrying out the following actions for each road section:
b1) determining a set of neighboring road sections using the base map data;
b2) calculating transition vectors for each combination of the road section and a neighboring road section using the base map data;
b3) calculating an energy consumption value for each transition vector using an energy consumption forecast model; and
b4) calculating an energy consumption forecast value of the road section using the calculated energy consumption value for each transition vector; and
c) providing map data comprising the network of road sections and the calculated energy consumption forecast values.

16. The computer-implemented method as claimed in claim 15,
wherein the set of neighboring road sections contains all road sections that are directly connected to the road section.

17. The computer-implemented method as claimed in claim 15,
wherein the set of neighboring road sections contains all road sections that are connected to the road section by at least one other road section.

18. The computer-implemented method as claimed in claim 15,
wherein the base maps for at least some of the road sections have one or more of the following values: speed limit, road type, gradient, length.

19. The computer-implemented method as claimed in claim 15,
wherein the transition vectors have one or more of the following values: difference in speed limit, change of road type, gradient difference.

20. The computer-implemented method as claimed in claim 15,
wherein the energy consumption forecast model comprises at least one trained regression model which contains a mapping rule from transition vectors to energy consumption values.

21. The computer-implemented method as claimed in claim 20,
wherein the at least one regression model comprises at least one decision tree provided by a random forest.

22. The computer-implemented method as claimed in claim 15,
wherein in b4) the calculated energy consumption forecast value of the road section corresponds to a largest of the energy consumption values calculated in b3).

23. The computer-implemented method as claimed in claim 15,
the method further comprising the following actions:
d) determining a GPS location of an electric vehicle;
e) determining a maximum, reference energy consumption forecast value in an environment of the electric vehicle according to the GPS location using the map data.

24. The computer-implemented method as claimed in claim 23,
the method further comprising the following actions:
f) adjusting an energy management configuration of the electric vehicle for preheating a battery of the electric vehicle based on a reference energy consumption forecast value.

25. A non-transitory computer-readable storage medium containing instructions which cause at least one processor to implement a method as claimed in claim 15 when the instructions are executed by the at least one processor.

26. A system for generating map data with energy consumption forecast values for use in energy management of an electric vehicle, the system comprising:
at least one memory containing an energy consumption forecast model and/or base map data which comprises a network of road sections;
a backend computing device which is designed to carry out the following actions:
a) loading the base map data;
b) carrying out the following actions for each road section:
b1) determining a set of neighboring road sections using the base map data;
b2) calculating transition vectors for each combination of the road section and a neighboring road section, using the base map data;
b3) calculating an energy consumption value for each transition vector using the energy consumption forecast model;
b4) calculating an energy consumption forecast value of the road section using the calculated energy consumption values; and
c) providing map data comprising the network of road sections and the calculated energy consumption forecast values.

27. The system as claimed in claim 26, wherein the system further comprises an electric vehicle comprising:
a GPS sensor;
a communication device; and
a vehicle computing device;
wherein the vehicle computing device is configured to:
determine a position of the electric vehicle using the GPS sensor;
transmit the position to the backend computing device by means of the communication device; and
receive a reference energy consumption forecast value from the backend computing device by means of the communication device; and
wherein the backend computing device is further designed to determine the reference energy consumption forecast value based on the position and the map data and to transmit said value to the communication device.

28. The system as claimed in claim 27,
wherein the electric vehicle further comprises:
an energy management device; and
a heater for heating a battery of the electric vehicle,
wherein the energy management device is designed to control the heater depending on the reference energy consumption forecast value.

29. The system as claimed in claim 26, wherein the set of neighboring road sections contains all road sections that are directly connected to the road section.

30. The system as claimed in claim 26, wherein the set of neighboring road sections contains all road sections that are connected to the road section by at least one other road section.

31. The system as claimed in claim 26, wherein the base maps for at least some of the road sections have one or more of the following values: speed limit, road type, gradient, length.

32. The system as claimed in claim 26, wherein the transition vectors have one or more of the following values: difference in speed limit, change of road type, gradient difference.

33. The system as claimed in claim 26, wherein the energy consumption forecast model comprises at least one trained regression model which contains a mapping rule from transition vectors to energy consumption values.

34. The system as claimed in claim 33, wherein the at least one regression model comprises at least one decision tree provided by a random forest.
